(19) United States
(12) Patent Application Publication
(10) Pub. No.: US 2002/0083900 A1
(43) Pub. Date: Jul. 4, 2002

(54) Portable pet-feeding container

(76) Inventor: Brian J. Williams, Mission Viejo, CA (US)

Correspondence Address: Alan H. MacPherson, SKJERVEN MORRILL MacPHERSON LLP, Suite 700, 25 Metro Drive, San Jose, CA, 95110-1349, US

(21) Appl. No.: 09/753,028

(22) Filed: Jan. 2, 2001

(51) Int. Cl. A01K 1/10; A01K 5/00; A01K 39/00

(52) U.S. Cl. 119/51.01

(57) ABSTRACT

A portable pet-feeding container and method for using a portable pet-feeding container and system when traveling with a pet. The portable pet-feeding container includes a reservoir, a removable lid which seals the open top of the reservoir, a skirt which surrounds the reservoir and includes a leash coupling means, and a handle connected to the skirt. A portable pet-feeding container system includes two similar portable pet-feeding containers coupled to one another to hold both food and water when traveling with a pet.

### FIELD OF THE INVENTION

The present invention relates to feeding accessories for pets, and more particularly to a portable pet-feeding container for making food and water accessible to a pet while at home or when traveling.

### BACKGROUND OF THE INVENTION

Just as with humans, it is important that pets be provided with food and water, whether at home or while traveling. Dogs in particular are taken many places by walking, car, train, plane, or by a combination of the aforementioned transportation means. Many times, food or water and other supplies are not adequately available when traveling with a dog, especially when walking or jogging.

For example, it is often inconvenient to simply carry food and water on short trips or walks with a dog. Although some owners may take these necessities along, it is cumbersome to simultaneously carry separate food and water containers and control the dog.

Further, many people use separate containers for food and water when at home and when traveling with the pet because the containers used at home do not seal to hold food or water and are cumbersome to travel with. To eliminate this duplicity of feeding containers for home and travel a portable pet-feeding container which can hold food and water and be easily transported while traveling with the pet is needed.

### SUMMARY

In accordance with the present invention, a portable pet-feeding container and method are provided for use while traveling with a pet. The portable pet-feeding container includes a reservoir for holding food or water, a lid to seal the reservoir, a skirt, surrounding the reservoir, which includes structure for attaching a leash, and a handle connected to the skirt. Advantageously, the portable pet-feeding container can be used to hold food or water or other supplies and can be transported conveniently while traveling with a pet.

In one aspect of the present invention, a portable pet-feeding container system is provided which includes two portable pet-feeding containers removably connected to one another. The system can be used to hold both food and water and other supplies simultaneously and can be transported conveniently while traveling with a pet.

In another aspect of the present invention, a method is provided for using the portable pet-feeding container while traveling with a pet. The method includes providing a portable pet-feeding container with at least one reservoir for holding food and/or water, said at least one reservoir having a skirt around the outside of the reservoir to allow the container to sit on a floor; providing leash coupling structure attached to the reservoir; providing food or water in the reservoir; fastening a removable lid onto the open top of the reservoir to seal the reservoir; connecting a leash to the leash coupling structure; connecting the other end of the leash to a pet; providing a handle on the container for use in carrying the portable pet-feeding container and to control the pet; wrapping the leash around the skirt to shorten the leash as necessary; and traveling with the pet from a first location to a second location.

In yet another aspect of the present invention, a method is provided for using the portable pet-feeding container while traveling with a pet. The method includes providing a first pet-feeding container with a first reservoir surrounded by a first skirt to allow the first container to sit on a floor; providing a second pet-feeding container with a second reservoir surrounded by a second skirt to allow the second container to sit on a floor; providing food and/or water in the first and second reservoirs; coupling said first skirt to said second skirt such that a first skirt base is alignable to a second skirt base; providing leash coupling structure on the first pet feeding container; connecting one end of a leash to the leash coupling structure; connecting the other end of the leash to a pet; using the handles to carry the pet-feeding container system and control the pet; and shortening the leash as necessary by wrapping the leash around the skirt. The method may include the additional step of traveling with the pet from a first location to a second location.

A more complete understanding of the invention can be obtained by reference to the following detailed description of the preferred embodiments thereof in connection with the attached drawings.

### BRIEF DESCRIPTION OF THE DRAWINGS

FIGS. 1A-1E are simplified top, side, handle end, leash-connecting end, and bottom elevation views of an embodiment of the portable pet-feeding container 1 of the present invention;

FIGS. 2A-2D illustrate an embodiment of the invention with a removable lid 7 and a storage cavity 19;

FIGS. 3A and 3B show an embodiment of a removable splash resistant ring 36 of the present invention for screwing into the top opening 2a and for providing a splash resistant opening in the top of reservoir 2;

FIGS. 4A and 4B are simplified top and side views of an embodiment of the portable pet-feeding container system of the present invention comprising two containers 1a, 1b, each of the type shown in FIGS 1A-1E;

FIGS. 5A-5C are simplified views of an embodiment of the hinge coupling structure of the present invention used to rotatably connect containers 1a, 1b to form feeding system 101 as shown in FIGS. 4A and 4B;

FIGS. 6A and 6B are schematic views of a method of using the portable pet-feeding container and system while traveling with a pet from one location to another;

FIGS. 7A, 7B, 7C and 7D illustrate an additional embodiment of the invention, wherein protuberances 12a and 12b from one end of container 1 comprise hooks for overlapping the rod 91 about which two containers 1a and 1b rotate;

FIGS. 8A, 8B and 8C illustrate various ways of carrying the pet food container 1 or the pet food system made up of two such pet food containers 1a, 1b while walking the pet;

FIGS. 9A, 9B, 9C, 9D and 9E illustrate an alternative hinge for joining the containers 1a and 1b to form the pet food system of this invention;

FIGS. 10A, 10B, and 10C show an additional alternative embodiment for joining containers 1a and 1b to form another pet food system of this invention.

FIGS. 11A, 11B, 11C, 11D and 11E show a variation of the structures shown in FIGS. 9A, 9B, 9C, 9D, and 9E wherein instead of a protuberance 97 on container 1, recessed trapezoidal area 97 is used on container 1 together with protuberances 94 and 95 on hinge 92; and

FIGS. 12A through 12D show a hinge structure wherein the hinge 122 has sections 123a and 123b together with protuberances 124a and 124b which insert into slots 125a and 125b in the containers 1a and 1b to lock the ends of containers 1a and 1b together to form a feeding system in accordance with this invention.

The use of similar reference numerals in different figures indicates similar or identical items.

### DETAILED DESCRIPTION OF THE PREFERRED EMBODIMENTS

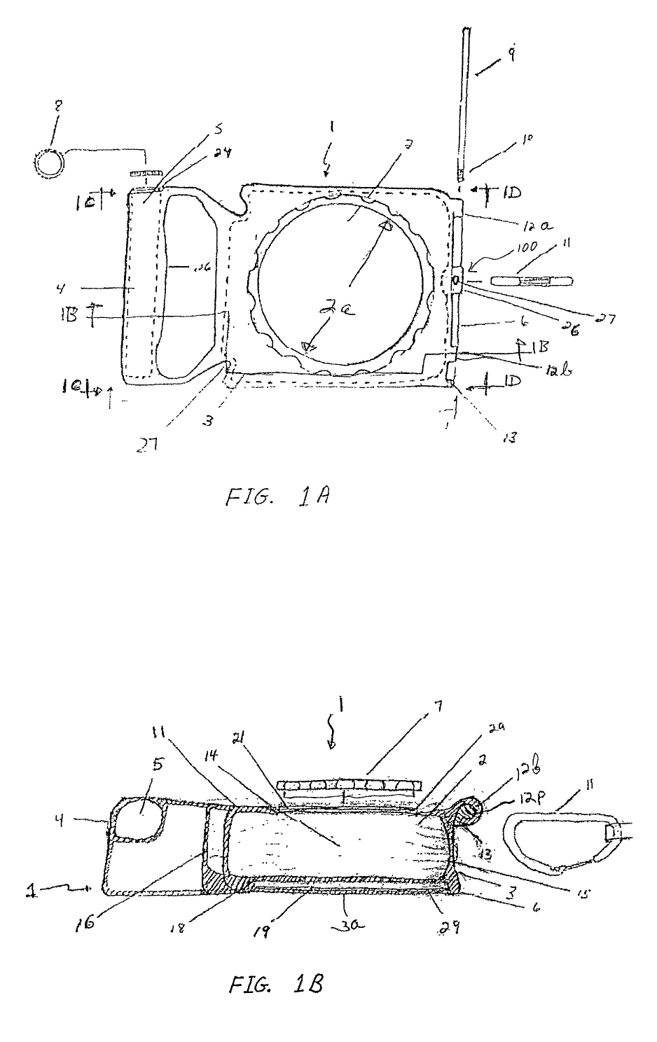

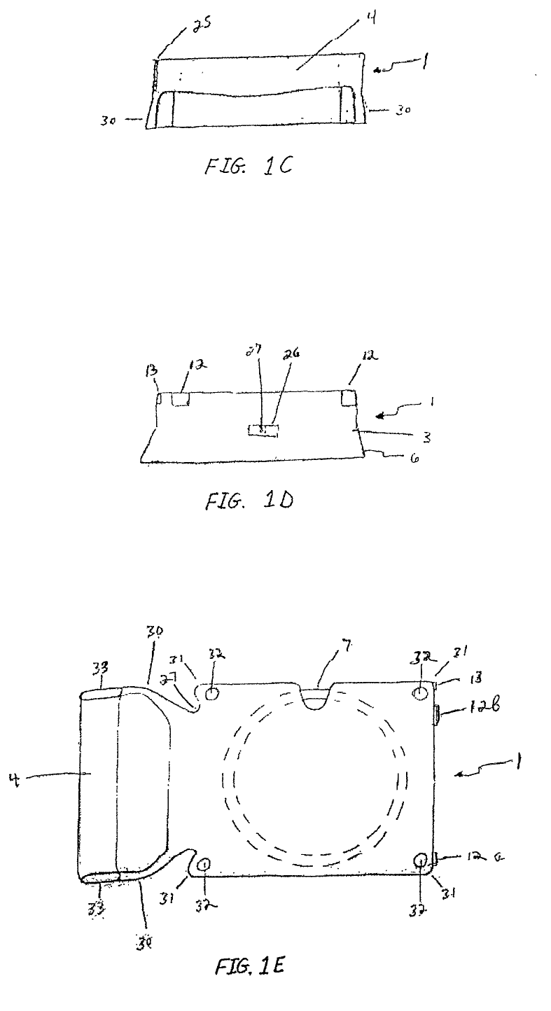

The present invention provides a portable pet-feeding container 1. Pet-feeding container 1 includes a reservoir 2 (FIG. 1B), a removable lid 7, a skirt 3 (FIG. 1A), which includes a leash coupling structure 100 surrounding and formed integrally with reservoir 2, and a handle 4 for holding pet-feeding container 1 when traveling with a pet.

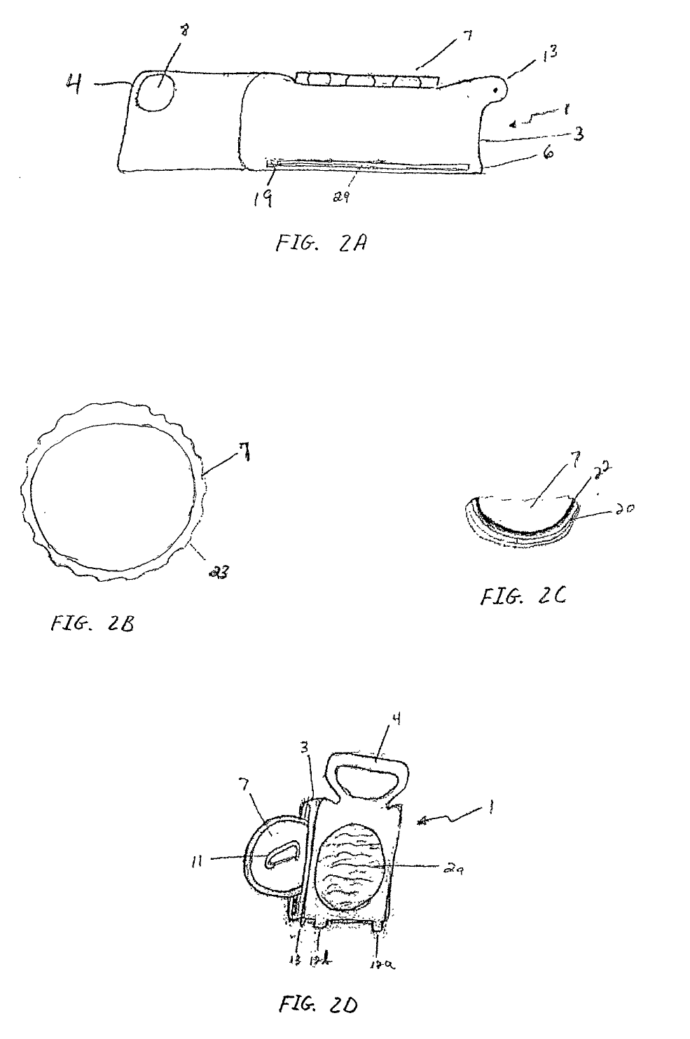

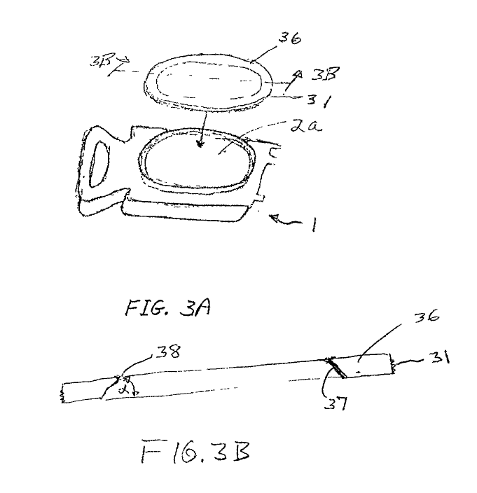

As shown in the embodiment of FIGS. 1A and 1B, reservoir 2 is integrated within skirt 3 to hold food or water. Reservoir 2 extends outwardly nearly to the edge of skirt 3. A circular opening 2a is formed in the top surface of reservoir 2. In one embodiment, the inner circumference of opening 2a is threaded to receive removable lid 7 (FIGS. 2A-2D) or spill resistant ring 36 (FIG. 3). In one embodiment, illustrated in FIGS. 2A through 2D, removable lid 7 is a twist top lid that seals opening 2a of reservoir 2.

FIGS. 2A, 2B, 2C, and 2D show an alternative embodiment of the container of this invention with top 7 placed on the container. An opening 19 is formed in the bottom of the container 1 and lip or ridge 29 is formed at the edge of this opening to hold top 7 in place when top 7 is stored in opening 19. The bottom 6 of skirt 3 slightly flared out to show the bottom of skirt 3. Cap 8 is shown on the end of tube 5 in the handle 4 of the container. FIGS. 2B and 2C show top 7 with screw threads 20 on the outer circumferential surface of top 7 and a rubber grommet 22 to help seal the container when top 7 is firmly screwed into place. FIG. 2B shows nodules 23 around the circumference of the top surface of removable lid 7 to provide grips for the hand and fingers when twisting lid 7 into opening 2a. of course, other methods for attaching top 7 to the container can be employed including a pop-on top if desired.

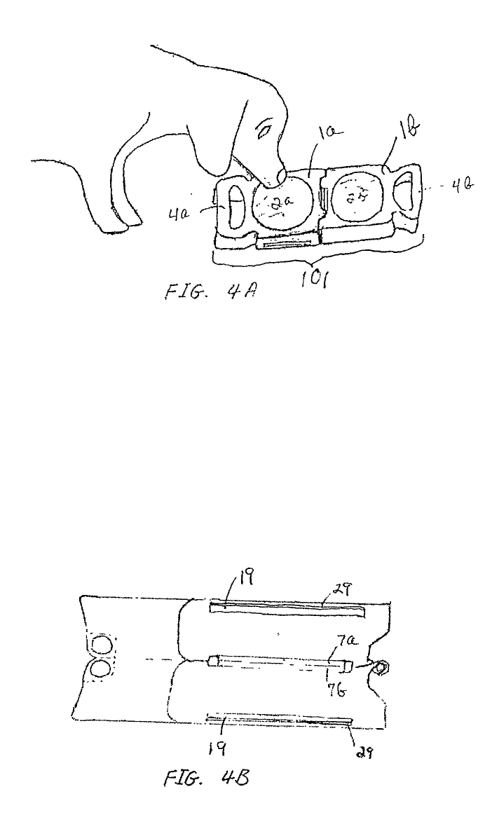

FIG. 2D shows an isometric view of the container 1 of this invention with the top 7 partially inserted into the opening 19 in the bottom of the container 1 and with a handle 4 on top 7 clearly shown in relation to the main body of the container along with protuberances 12a, 12b and 13 on the opposite end of the container from handle 4. The role of protuberances 12a, 12b and 13 will be discussed below in connection with FIGS. 4A, 4B, 5A, 5B and 5C. Top 7 is shown in FIG. 2D having a handle 11 which allows the top 7 to be more easily turned.

FIGS. 3A and 3B show a spill reducing ring 36 capable of being inserted into opening 2a on container 1 to reduce the spillage of water when a dog or other animal drinks from container 1. Ring 36 has an interior surface 37 (FIG. 3B) angled at the angle a from the horizontal to reflect back into the container water or food that may be splashed out of the container while the dog is drinking or eating. The inner edge of the rim 38 is rounded to prevent a dog from cutting his/her tongue or skin on a sharp edge.

In one embodiment, spill resistant ring 36 may be threaded around its exterior circumference 31 to allow for twist insertion into opening 2a.

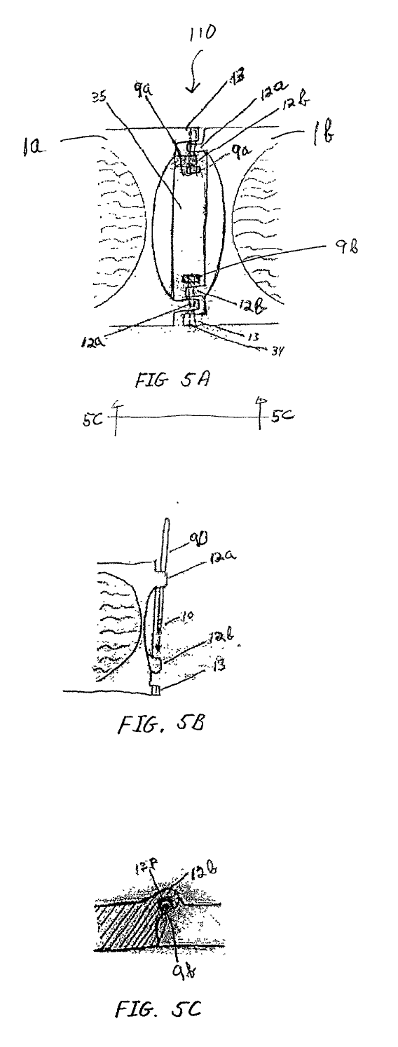

Referring again to FIGS. 1A and 1B, skirt 3 surrounds reservoir 2 in one embodiment. As explained above, skirt 3 includes a cavity 19 for storing, for example, lid 7. Structure for coupling the leash includes a base block 26 with a hole 27, into which a clip 11 (or similar type mechanism) to which a leash is attached can be inserted. Clip 11 or similar mechanism can then be connected to a standard leash 28, as shown in FIG. 6A. In another embodiment, the leash coupling structure can include an automatically rewinding and releasing dog leash of well-known design incorporated into skirt 3.

Lid storage cavity 19 is located under reservoir 2, as illustrated in FIG. 1B. Clip 11 may also be stored in storage cavity 19. The bottom surface 3a of skirt 3 is flat to provide stability on a surface when used by a pet for eating or drinking. In one embodiment, rubber circlets 32 (FIG. 1E) are placed near each of the outer areas of the base of skirt 3 to provide stability and skid resistance for the portable pet-feeding container 1 when on a surface (FIG. 1E). Two additional elongated rubber pads 33 may be placed near the ends of the extensions 30 of the skirt 3 which hold handle 4 to provide extra stability.

In one embodiment, handle 4 is connected to skirt 3. Preferably, for strength and low manufacturing cost, handle 4 is molded as a single structure integral with skirt 3. The handle 4 and skirt 3 may include as an internal part thereof additional structure such as metal bands or wires or any other material which will add strength to the handle/skirt structure. In other embodiments, handle 4 may be modular and connected to skirt 3 by screws, rivets or adhesive, for example. Whichever attachment structure is used, the attachment must be strong enough to hold together the handle 4 and skirt 3 when tugged by a strong dog. In one embodiment handle 4 includes a storage tube 5 and a removable storage tube lid 8, as shown in FIGS. 1A and 1B. Storage tube 5 can hold small items, such as a clean up bag, small amounts of food or even a cord for use in tying the dog. One end of storage tube 5 is threaded to receive the threads on the outer circumference of a cap 8 which can be screwed into or onto tube 5 to seal tube 5. Storage tube cap or lid 8 may also include a rubber gasket like that described in conjunction with removable lid 7 to seal tube 5.

Skirt 3 also includes side grooves 27 near the interface between handle 4 and skirt 3 (FIGS. 1A and 1E). Grooves 27 are provided to allow a user to adjust the standard leash length when using the portable pet-feeding container by wrapping the leash around skirt 3 utilizing the grooves as shown in FIG. 6B, for example.

The aforementioned parts of portable pet-feeding container 1, including reservoir 2, removable lid 7, skirt 3, and handle 4, can be made from plastic, rubber, or metal.

FIG. 1B, a cross-sectional side view along the line labeled 1B of the structure shown in FIG. 1A, shows that bottom 18 of reservoir 2 seals the top of cavity 19 in which can be placed top 7. Top 7 is shown in exploded view removed from the structure of FIG. 1B. The inner circumference of opening 2a is threaded to mate with threads on the circumference of top 7 thereby to allow top 7 to be screwed into opening 2a to form a leak proof seal with the top of reservoir 2.

In another embodiment, cap 8 is a snap-on cap of any one of several types well-known in the art.

FIG. 1C shows the end view of container 1 in FIG. 1A as shown by the arrows 1C in FIG. 1A. Handle 4 is clearly visible in the top of FIG. 1C.

FIG. 1D shows the end view of container 1 as shown by the arrows 1d in FIG. 1A. Note that structure 100, namely tab 26 with opening 27 integrally formed as part of skirt 3 for holding a leash is clearly shown in FIG. 1A and in an end view of FIG. 1D.

FIG. 1E shows the view of the container of FIG. 1A from the bottom and shows the rubber pads 32 for use in placing the container on a floor so that the container can be used to allow the dog to eat the food or drink the water contained therein.

In another embodiment, shown in FIGS. 4A and 4B, two similar portable pet-feeding containers 1a and 1b are removably coupled to one another to form a portable pet-feeding container system. In this embodiment, both food and water may be carried when traveling with a pet. The first and second portable pet-feeding containers are rotatably and removably coupled to one another such that when folded, the tops of both pet-feeding containers are adjacent to one another, as illustrated in FIG. 4B. When folded together for transport, handles 4a and 4b line up and come together to form a combined carrying handle while tops 7a and 7b are directly adjacent each other. Each top 7a and 7b seals the corresponding reservoir to allow food and water to be carried in leak proof containers while traveling.

FIGS. 5A through 5C illustrate one embodiment of a hinge mechanism to be used to couple first portable pet-feeding container 1a to second portable pet-feeding container 1b to form the feeding system of FIGS. 4A and 4B. Hinge mechanism 110 includes two arms 12a, 12b on container 1b, two arms 12a, 12b on container 1a, and an end wall 13 on each portable pet-feeding container 1a, 1b as illustrated in FIG. 5A. The two portable pet-feeding containers may be aligned so that the arms 12a, 12b and end walls 13 are interdigitated as shown in FIG. 5A. Two pins 9a and 9b, each with one threaded end, are inserted through holes in arms 12a and 12b and each are screwed into a threaded hole 34 in a corresponding end wall 13, as illustrated in FIG. 5A. FIG. 5C shows the view from the bottom of FIG. 5A when containers 1a and 1b are joined together by pins 9a and 9b.

As shown in FIGS. 1A and 5A (FIG. 5A is looking at the container from the bottom of FIG. 1A), protuberances 12a, 12b and 13 are arranged such that when the containers 1a and 1b are placed so as to be joined by pins 9a and 9b, protuberance 12a on container 1b is inserted in the slot between end 13 and protuberance 12b on container 1a while protuberance 12a on container 1a is inserted in the slot between protuberance 12b and end 13 on container 1b. Thus, containers 1a and 1b align symmetrically and parallel to each other when joined by pins 9a and 9b.

Alternatively, a single rod 90, as shown in FIG. 5B, can be inserted through the openings in arms 12a, 12b on the two containers as well as through corresponding openings in end walls 13 and secured in position by fasteners of well-known design, such as lock washers and nuts.

FIGS. 6A and 6B show a method for using the portable pet-feeding container 1 (FIG. 1A) and system 101 (FIG. 4A) when traveling with a pet. The portable pet-feeding container 1 or system 101 can be used by itself to carry food or water but as shown above in conjunction with FIGS. 4A, 4B, 5A, 5B and 5C, the portable pet-feeding container 1a (FIG. 4A) can also be coupled to a similar portable pet-feeding container 1b to form a system 101 for carrying both food and water when traveling with a pet. A removable lid 7 is fastened over the reservoirs 2a and 2b containing food or water. One end of a standard leash 28 (FIG. 6A) is then connected to the leash coupling structure and the other end of the standard leash 28 is connected to a pet. The handle of either a single portable pet-feeding container 1 (FIG. 1A) or the combined handles on the two containers 1a, 1b, making up a portable pet-feeding container system 101 (FIG. 4A) can be used like a leash handle to control the pet. The leash 28 may also be shortened as necessary by wrapping the leash 28 around the skirt 3 using the grooves 27 to hold the wrapped-around leash 28. Then the pet and owner can travel from one location to a second location with food and/or water.

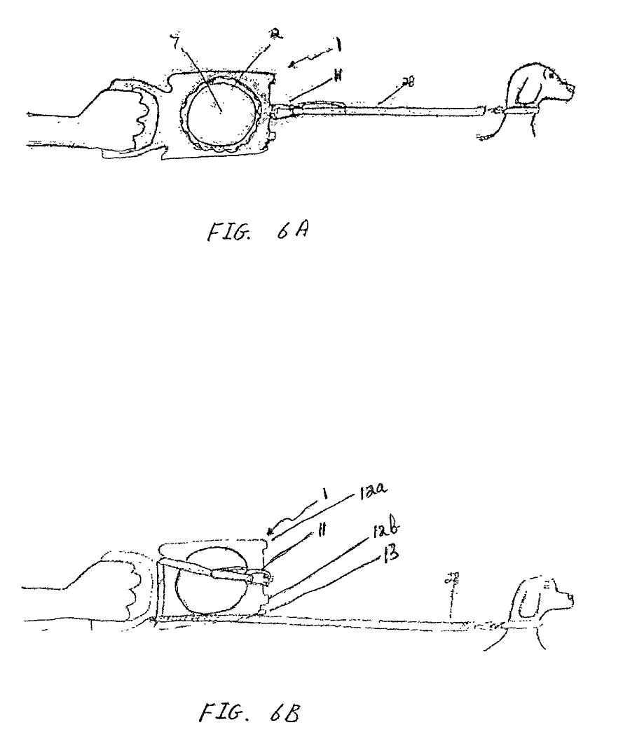

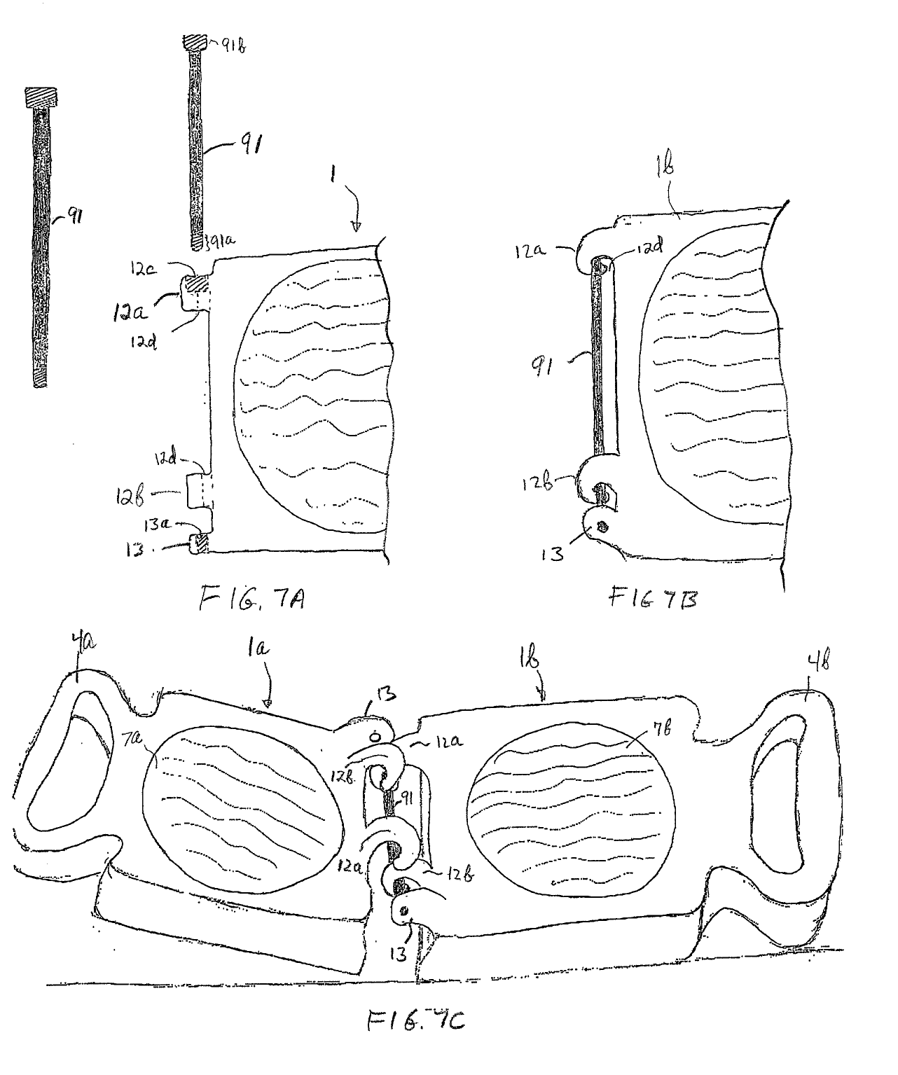

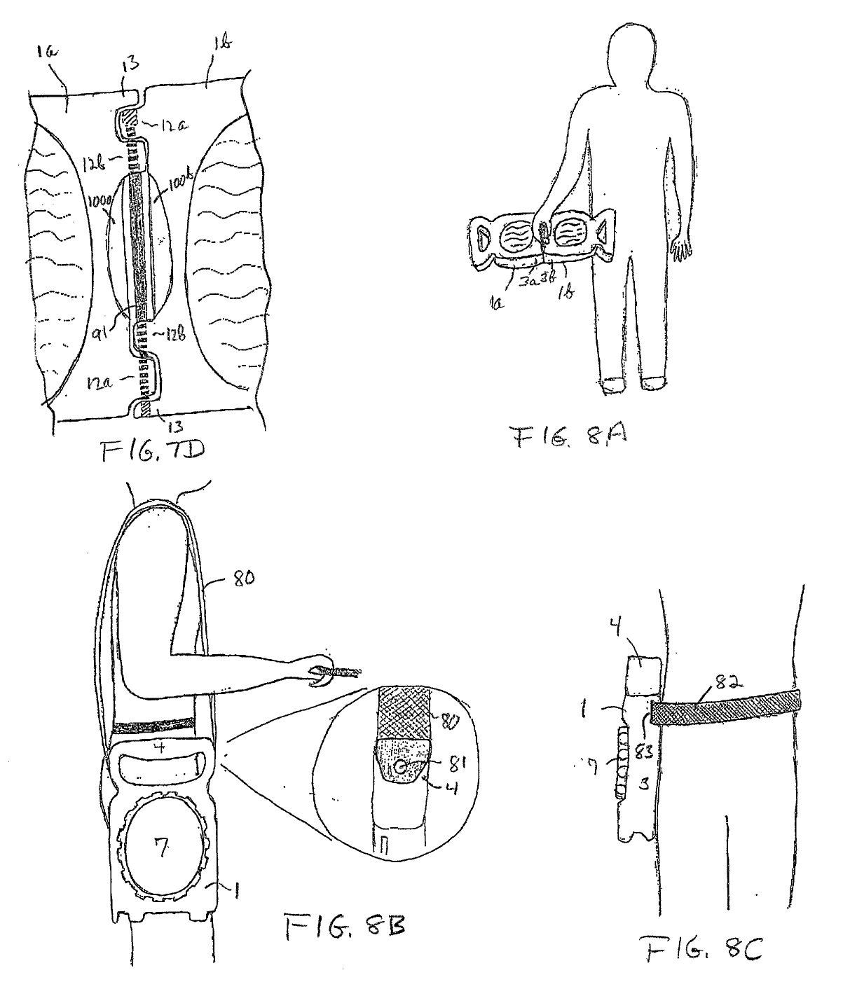

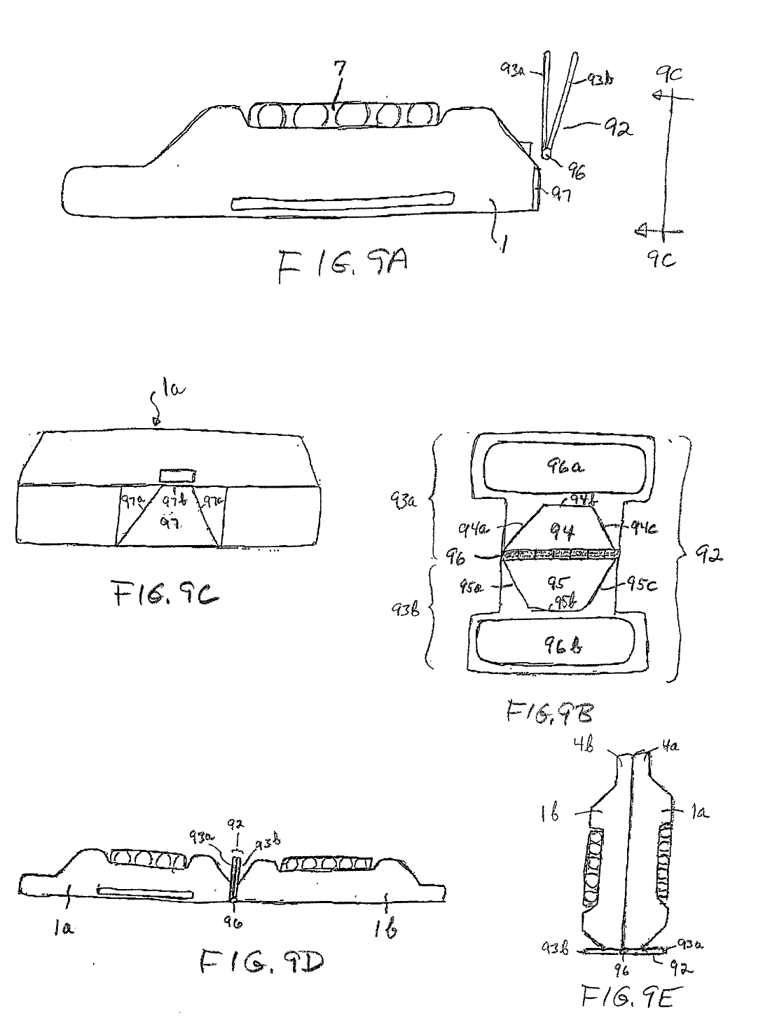

The embodiment shown in FIG. 7A through 7D utilizes hooks as protuberances 12a and 12b on containers 1a and 1b, to form the pet food system of this invention. As shown in FIG. 7A, rod 91 has threads on end 91a for allowing rod 91 to be threaded into the threaded opening 13a of end protuberance 13. Head 91b of rod 91 recesses into and rests in cavity 12c formed in the outer side of protuberance 12a. As shown in FIGS. 7B and 7C, protuberances 12a and 12b are shaped like hooks with enough space 12d between the end of container 1b and the end of each hook 12a, 12b to allow rod 91 to be slid into place so as to contact the interior surfaces of hooks 12a and 12b. Once rod 91 has been so placed and screwed into the interior threads on opening 13a in end protuberance 13, a second container 1a can be joined to container 1b by lifting the handle 4a on container 1a such that the hooks 12a and 12b on container 1a can slip in place over rod 91 already firmly ensconced in the hooks 12a and 12b of container 1b and thereby lock container 1a to container 1b. Note that hook 12a on container 1a will fit between hook 12b and protuberance 13 on container 1b, while hook 12a on container 1b fits between hook 12b and end protuberance 13 on container 1a. Note further that the head 91b (FIG. 7A) of rod 91 is contained within cavity 12c of hook 12a on container 1b and therefore end protuberance 13 on container 1a not only is able to slide into place beside protuberance 12a on container 1b, but end protuberance 13 also locks in place rod 91 as shown in FIG. 7D so that rod 91 cannot become dislodged. Thus in one embodiment, threads on the interior of opening 13a in end protuberance 13 and on the end 91a of rod 91 are not needed thereby simplifying the structure and lowering the cost.

An advantage of this system is that containers 1a and 1b are easily joined together merely by hooking hooks 12a and 12b on one container over rod 91, when rod 91 is in place within hooks 12a and 12b on the other container. When this happens, hooks 12a and 12b on container 1a together with hooks 12a and 12b on container 1b lock rod 91 in place so that the two containers 1a and 1b cannot be dislodged by the animals while eating food. Moreover, when the containers 1a and 1b are rotated about rod 91 so that the tops 7a and 7b of the two containers are directly in contact with each other, the hooks 12a and 12b and protuberance 13 on container 1a together with hooks 12a and 12b and protuberance 13 on container 1b prevent rod 91 from being dislodged.

As shown in FIGS. 8A through 8C, the user can carry containers 1a and 1b when combined as a system by lifting the containers using rod 91 as a handle. Note in FIG. 7D areas 100a and 100b are left open, allowing fingers of a user to be inserted around rod 91 to carry the two containers 1a and 1b as a unit. Moreover, skirts 3a and 3b on the two containers abut directly as shown in FIG. 8A thereby to prevent containers 1a and 1b from taking a position other than horizontal while being carried upright as shown in FIG. 8A. FIG. 8B shows a shoulder harness 80 with a buckle 81 for snapping into a protuberance on handle 4 of container 1 to allow the container 1 with the top 7 in place to be carried over the shoulder of the pet owner. FIG. 8C shows a belt 82 inserted through a slot 83 in skirt 3 of container 1 to allow the container to be carried around the waist of the user. Note that handle 4 is preferably at the top of the container when the container is carried using belt 82.

FIGS. 9A through 9E show an alternative hinge 92 for use with this invention to join container 1a to container 1b. In FIGS. 9A through 9E, hinge 92 has two portions 93a, 93b each of which contains an opening, 96a and 96b, respectively, to allow the user to use the top portion of hinge 92 as a handle when portions 93a and 93b are folded to be essentially vertical and in touch with each other as shown in FIG. 9D. The hinge 92 is joined to each of containers 1a and 1b by a snap fit involving the insertion of a trapezoidal extension 97 of container 1 into the trapezoidal opening 94 of section 93a of hinge 92. Trapezoidal extension 97 on the right end of container 1 (FIG. 9A) is shown in end view in FIG. 9C. Trapezoidal extension 97 snap fits into trapezoidal opening 94 in hinge section 93a of hinge 92. A similar trapezoidal extension 97 on a second container 1b snap fits into trapezoidal opening 95 on section 93b of hinge 92. Sections 93a and 93b rotate about pin 96 as shown in FIGS. 9A, 9D and 9E to allow containers 1a and 1b to be joined as shown. In FIG. 9D, hinge sections 93a and 93b are directly abutting each other such that openings 96a and 96b come together to form a handle with an opening for use by an owner in lifting the system containing containers 1a and 1b. FIG. 9E shows containers 1a and 1b folded together such that the bottoms of the containers 1a and 1b are directly adjacent each other causing sections 93a and 93b of hinge 92 to lie in the same plane. The two containers 1a and 1b then can be carried using the combined handles 4a and 4b. Note that trapezoidal sections 94 and 95 are formed such that sides 94a, 94b, and 94c of trapezoid 94 directly abut and lock in contact with edges 97a, 97b and 97c of trapezoidal abutment 97 on container 1a. Likewise, a similar trapezoidal abutment 97 on container 1b has sections 97a, 97b and 97c in direct contact with edges 95c, 95b and 95a of trapezoidal opening 95 in section 93b of hinge 92. Note that edge 97a of abutment 97 from container 1b contacts and snap locks edge 95c of trapezoidal opening 95 in section 93b of hinge 92 because the container 1b is essentially rotated 180° from the location of container 1a even though the two containers 1a and 1b are identical.

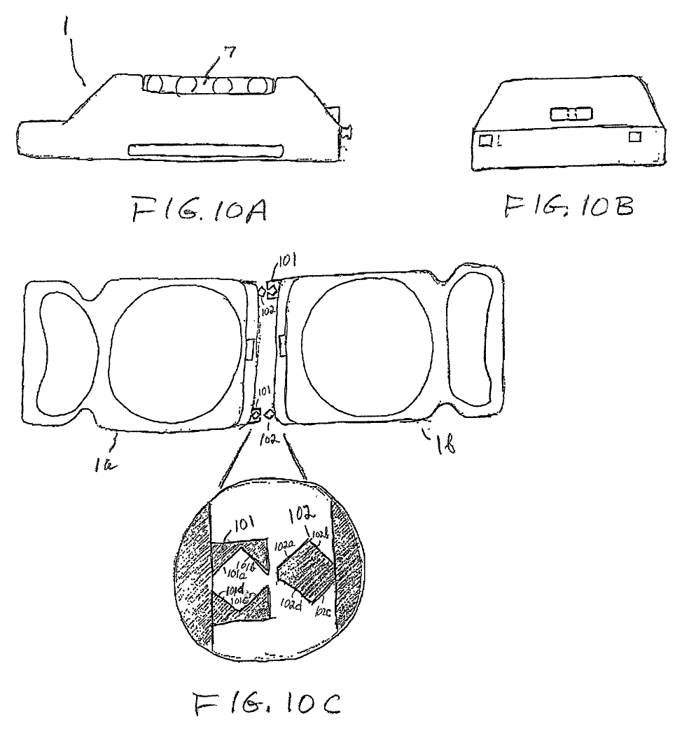

FIGS. 10A, 10B and 10C show an additional embodiment of the invention, wherein containers 1a and 1b are formed with symmetric attachment tabs 101 and 102 formed thereon. Tab 101 is a solid block of material with a square opening formed therein containing sides 101a, 101b, 101c, and 101d. Tab 102 is a solid square block formed on the end of container 1, such as to fit in the square opening of tab 101 such that sides 102a, 102b, 102c and 102d of tab 102 are located directly adjacent to and in contact with sides 101a, 101b, 101c and 101d, respectively, of tab 101. This contact directly locks container 1a to container 1b. Note, however that the containers are not able to be rotated relative to each other using this connection system to attach container 1a to container 1b.

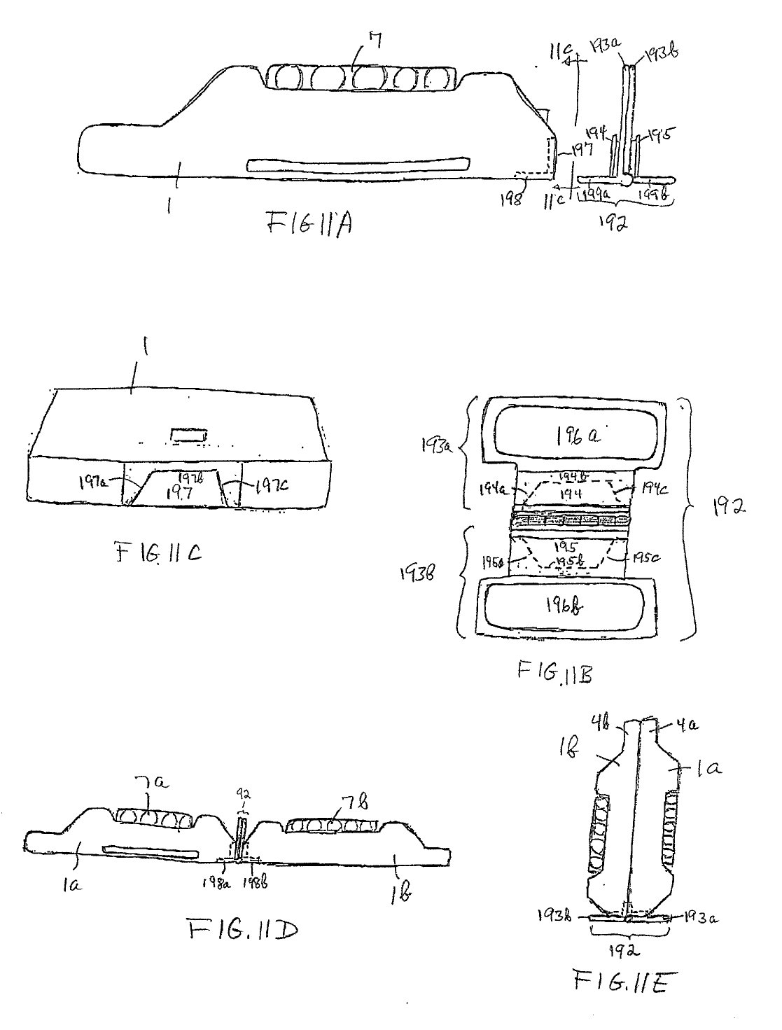

The structure shown in FIGS. 11A through 11E is similar to the structure shown in FIGS. 9A through 9E except that abutment 97 on container 1 in FIGS. 9A through 9E has been replaced by a recessed trapezoidal area 197 on container 1 to receive a trapezoidal abutment 194 or 195 on hinge 192 and by a recessed slot 198 in the bottom of the container 1 to receive a portion 199a or 199b of hinge 192. As shown in FIG. 11C, recessed trapezoidal area 197 on container 1 is sized to receive protuberance 194 on hinge 192 such that sides 194a, 194b and 194c of protuberance 194 snap fit and thus mate with sides 197a, 197b and 197c of trapezoidal recess 197 when dishes or containers 1a and 1b are joined together using hinge 192. Trapezoidal abutment 194 from section 193a of hinge 192 mates with the trapezoidal recess 197 of dish 1a so as to form a forced fit connection. Simultaneously, trapezoidal abutment 195 on hinge section 193b mates in a forced fit connection with trapezoidal recess 197 in dish 1b so that sides 195c, 195b and 195a of abutment 195 are directly adjacent to sides 197a, 197b and 197c, respectively of trapezoidal recess 197 in container 1b. In addition, extension 199a of section 193a of hinge 192 extends into the recess 198 formed in the bottom skirt 3 of container 1 while extension 199b of hinge section 193b extends into the similar recess 198b (FIG. 11D) in container 1b. A user can fold containers 1a and 1b such that handles 4a and 4b form a combined handle for carrying the container system as shown FIG. 1E.

Note that the edges of trapezoidal (or any other appropriate shape) abutments 194, 195 are slightly larger on the outer side than on the side of abutments 194, 195 closest to the center plane of hinge 192 while the inner dimensions of trapezoidal opening 197 are slightly larger than the outer dimensions of opening 197 to ensure a snap fit of containers 1a and 1b on hinge 192.

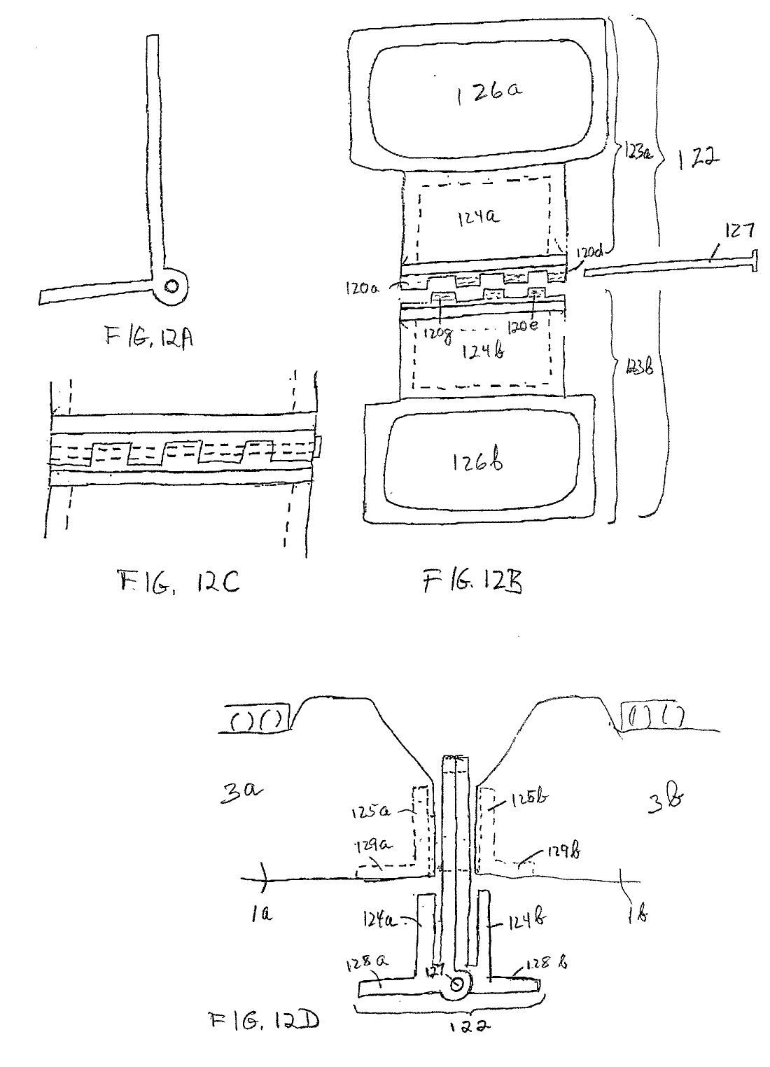

FIGS. 12A, 12B, 12C and 12D show an alternative hinge structure 122 for use with this invention. Vertical tabs 124a and 124b extend from hinge sections 123a and 123b, respectively, for insertion into slots 125a and 125b on containers 1a and 1b, respectively, to form a container system as disclosed in this invention. Tab 124a on hinge section 123a inserts into slot 125a in skirt 3a of container 1, while tab 124b on hinge section 123b inserts into slot 125b in skirt 3b of container 1b as shown in FIG. 12D. Extensions 128a and 128b on hinge sections 123a and 123b, respectively, fit into recesses 129a and 129b in skirts 3a and 3b, respectively. Rod 127 allows hinge sections 123a and 123b to rotate with respect to each other. Rod 127 is inserted through openings in tabs 120a through 120d (FIG. 12B) contained on hinge section 123a and, through openings in interdigitated mating tabs 120e through 120g on hinge section 123b.

Openings 126a and 126b are formed in hinge sections 123a and 123b, respectively, to allow a user's hand to lift the combined container system including containers 1a and 1b (FIG. 12D) when hinge 122 is used to join containers 1a and 1b to form the container system.

Although the present invention has been described with reference to specific embodiments, these embodiments are illustrative only and not limiting. Many other applications and embodiments of the present invention will be apparent in light of this disclosure and the following claims.

What is claimed is:

1. A portable pet-feeding container, comprising:
a reservoir with an open top;
a removable lid for sealingly covering said open top of said reservoir;
a skirt surrounding said reservoir, said skirt including structure for attaching a leash; and
a handle connected to said skirt.

2. The portable pet-feeding container of claim 1, wherein said structure for attaching a leash is a nodule with a hole.

3. The portable pet-feeding container of claim 1, wherein said handle comprises a storage tube and a removable storage tube lid.

4. The portable pet-feeding container of claim 1, wherein said skirt has a top surface and side surfaces extending downwardly to a flat base.

5. The portable pet-feeding container of claim 4, wherein said flat base includes a cavity for lid storage.

6. The portable pet-feeding container of claim 4, wherein said flat base comprises a movement-preventing structure for securing said portable pet-feeding container to a surface to prevent movement of said pet-feeding container on said surface.

7. The portable pet-feeding container of claim 6, wherein said movement securing structure includes rubber circlets attached to the bottom surface of said flat base.

8. The portable pet-feeding container of claim 1, wherein said skirt includes grooves for holding a leash which is wrapped around said container.

9. The portable pet-feeding container of claim 1, wherein said reservoir is within said skirt.

10. The portable pet-feeding container of claim 1, wherein said reservoir has an open top with a threaded inner surface for receiving a spill resistant ring and said removable lid.

11. The portable pet-feeding container of claim 1, wherein said removable lid has a threaded side surface and a notched top surface for sealably twisting said removable lid onto an open top of said reservoir.

12. The portable pet-feeding container of claim 1, wherein said reservoir, said removable lid, said skirt, and said handle, are comprised of materials selected from the group consisting of metal, rubber, and plastic.

13. A portable pet-feeding container system, comprising a first portable pet-feeding container removably coupled to a second portable pet-feeding container.

14. The portable pet-feeding container system of claim 13, wherein said first portable pet-feeding container comprises:
a first reservoir with an open top;
a first removable lid for sealingly covering said open top of said first reservoir;
a first skirt surrounding said first reservoir, said first skirt including a leash coupling structure; and
a first handle connected to said first skirt.

15. The portable pet-feeding container system of claim 14, wherein said second portable pet-feeding container comprises:
a second reservoir with an open top;
a second removable lid for sealingly covering said open top of said second reservoir;
a second skirt surrounding said second reservoir, said second skirt including a leash coupling structure; and
a second handle connected to said second skirt.

16. The portable pet-feeding container system of claim 15, wherein said first skirt is movably coupled to said second skirt by a detachable hinge connection.

17. The portable pet-feeding container system of claim 16, wherein said hinge connection comprises a rod, and arm hooks and an end wall extending from one end of each of said containers.

18. A method for traveling with a pet using a portable pet-feeding container, said method comprising:
providing a portable pet-feeding container;
providing food and/or water in a reservoir of said container;
fastening a removable lid onto an open top of said reservoir;
coupling one end of a leash to a said container;
coupling another end of said leash to a pet;
using a handle to carry the portable pet-feeding container while controlling the pet;
shortening a leash by wrapping said leash around a skirt, as necessary; and
traveling with pet from a first location to a second location.

19. A method for traveling with a pet using a portable pet-feeding container system, said method comprising:
providing a first portable pet-feeding container with a first reservoir, first skirt and first handle;
providing a second portable pet-feeding container with a second reservoir, second skirt and second handle;
providing food and/or water in the first and second reservoirs;
fastening first and second removable lids onto open tops of said first and second reservoir; and
coupling said first skirt to said second skirt such that said first lid is adjacent said second lid and said first handle is adjacent said second handle to form a composite handle.

20. The method of claim 19 further including:
coupling one end of a leash to said pet-feeding container system;
connecting another end of said leash to a pet;
using said composite handle to carry the portable pet-feeding container system while controlling the pet;
shortening a leash by wrapping said leash around at least one skirt, as necessary; and
traveling with a pet from a first location to a second location.
